(19) United States
(12) Patent Application Publication
(10) Pub. No.: US 2007/0263001 A1
(43) Pub. Date: Nov. 15, 2007

(54) Motion Capture Device for Capturing of Motion Relative to the Earth

(76) Inventor: Michael Trzecieski, Hong Kong (HK)

Correspondence Address: Michael Trzecieski, Flat 1A, Caineway Mansion, 130 Caine Rd., Mid Levels, omitted

(21) Appl. No.: 11/747,967

(22) Filed: May 14, 2007

Related U.S. Application Data
(60) Provisional application No. 60/747,210, filed on May 15, 2006.

(51) Int. Cl. G06T 15/70

(52) U.S. Cl. 345/473

(57) ABSTRACT

Motion capture is a field where sensors are disposed about an animate object and the motions of the object are recorded such that they can be represented as 3D graphics on a computer. Unfortunately, motion capture devices, such as motion capture suits that are currently available on the marker are very expensive. A novel motion capture device is disclosed for capturing motion of a human or animal limb in relation to the Earth's ground and magnetic field.

This application claims priority from U.S. Provisional Application No. 60/747,210 Filed on May 15, 2006.

### FIELD OF THE INVENTION

The field of the invention is related to the field of motion capture and more specifically in the area of using sensors that derive their information from parameters related to the Earth for facilitating motion capture.

### BACKGROUND OF THE INVENTION

Motion capture is an area where sensors are disposed about an animate object and the motions of the object are recorded. A skeletal model of the animate object along with the recorded motions of the object are then represented as 3D graphics on a computer.

Computer gaming is another area that is also benefiting from gaming controllers that are not only controlled using hands, but also using other body parts, such as arms and feet. Such controllers thereby allow a user to obtain more of a physical workout as opposed to just working out their fingers and hands.

Unfortunately, motion capture devices, such as motion capture suits and gaming controllers that are currently available on the marker are expensive.

It is therefore an object of the present invention to provide a motion capture device that provides motion capture relative to the earth.

### SUMMARY OF THE INVENTION

In accordance with the invention there is provided a motion capture device for being disposed in proximity of a moveable joint comprising: a first portion coupled in proximity of the movable joint; an accelerometer comprising an output port and coupled with the first portion for measuring an angular displacement of the first portion in relation to ground; a magnetic field sensor comprising an output port and coupled with the first portion for measuring an orientation of the first portion in relation to the earth's magnetic field; an angle measuring device comprising an output port and coupled with the first portion for measuring an angle of the moveable joint.

In accordance with the invention there is provided A method of motion capture comprising: providing a first portion coupled in proximity of the movable joint; providing an accelerometer comprising an output port and coupled with the first portion; providing a magnetic field sensor comprising an output port and coupled with the first portion; providing an angle measuring device disposed in proximity of the moveable joint; measuring an angular displacement of the first portion in relation to ground; measuring an orientation of the first portion in relation to the earth's magnetic field; measuring an angle of the moveable joint; processing the measured angular displacement and the orientation in relation to the earth's magnetic field in order to determine an orientation of the first portion in two axes; processing the angle of the moveable joint in order to determine a bending angle of the movable joint.

### BRIEF DESCRIPTION OF THE DRAWINGS

Exemplary embodiments of the invention will now be described in conjunction with the following drawings, in which:

FIG. 1a illustrates a motion capture device in accordance with a first embodiment of the invention;

FIGS. 2a and 2b illustrate a motion capture device in accordance with a second embodiment of the invention;

FIG. 3a illustrates the first embodiment of the invention being disposed in proximity of a knee moveable joint of a human operator for facilitating motion capture of the thigh as well as bending of the knee;

FIG. 3b illustrates the second embodiments of the invention being disposed in proximity of a knee moveable joint of the human operator for facilitating motion capture of the thigh as well as bending of the knee;

FIG. 4a illustrates the first and second embodiments of the invention being coupled with a control circuit for receiving of output signals provided by at least one of the first and second embodiments of the invention; and,

FIG. 5a illustrates an actuator with positional feedback, such as the angle measuring device, disposed in proximity of a moveable joint and coupled between a first portion and a second portion.

### DESCRIPTION OF EMBODIMENTS OF THE INVENTION

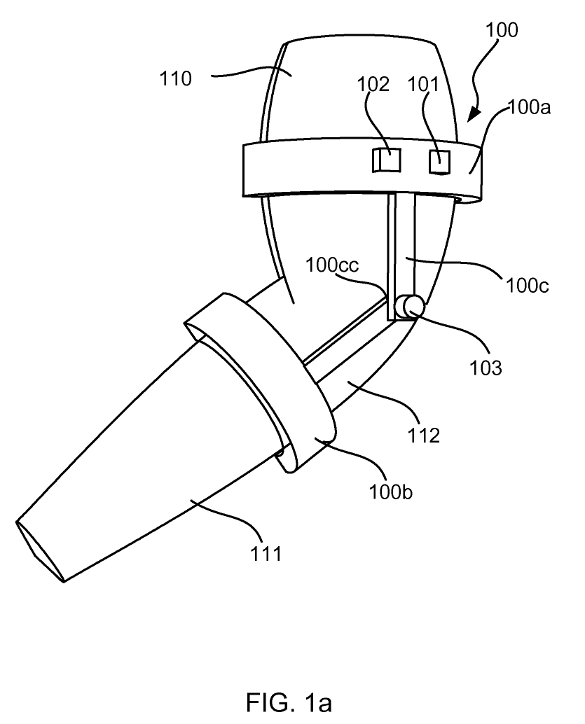

FIG. 1a illustrates a motion capture device 100 in accordance with a first embodiment of the invention. The motion capture device 100 is for use with in proximity of a moveable joint of an animate object, such as an elbow or knee of a human operator. Forming the motion capture device 100 is a first portion 100a, a second portion 100b and a coupling 100c between the first and second portions, 100a and 100b, respectively. Further disposed as part of the first portion 100a, is an accelerometer 101 as well as a magnetic field sensor 102. Preferably the accelerometer 101 is a dual axis accelerometer having a sensitivity of approximately plus or minus 2 Gs with the two sensing axes being approximately orthogonal. Preferably the magnetic field sensor 102 is a dual axis magnetic field sensor for sensing the earth's magnetic field in two approximately orthogonal axes. An angle measuring device, in the form of a variable resistor 103, is disposed as part of the coupling 100c and preferably coaxial with a pivot 100cc formed as part of the coupling for facilitating rotation of the second portion 100b relative to the first portion 100a along the pivot 100cc.

In use of the first embodiment of the invention 100 by the human operator, the first portion 100a is strapped to an upper arm 110, the second portion 100b is strapped to a lower arm 111 and the coupling is proximate an elbow moveable joint 112. Preferably the first embodiment of the invention 100 is worn on the body part of the human operator such that it allows for bending of the elbow moveable joint 112. During use of the first embodiment of the invention 100, the accelerometer 101 is for measuring the orientation of the upper arm 110 in relation to ground in two axes that are other than the same axis. The magnetic field sensor 102 is for measuring the orientation of the upper arm 110 in relation to the earth's magnetic field. Using a combination of the upper arm motion in two degrees in relation to ground as well determining the orientation of the upper arm in relation to the earth's magnetic field allows for determining the motion of a shoulder moveable joint of the human operator in two different axes and hence facilitates motion capture of the upper arm 110 movement. Bending of the elbow moveable joint 112 is determined by the angle measuring device, in the form of the variable resistor 103, where as the elbow moveable joint 112 moves the resistance of the variable resistor 103 changes and hence an angular range of motion of the elbow moveable joint 112 is determinable by the angle measuring device.

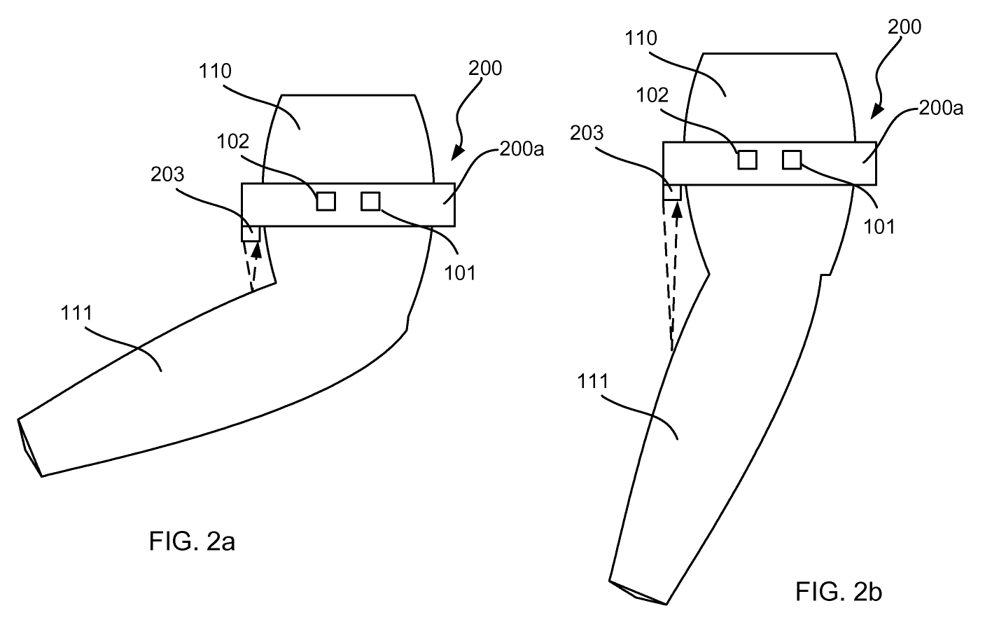

FIGS. 2a and 2b illustrate a motion capture device 200 in accordance with a second embodiment of the invention. The motion capture device 200 is for use with a moveable joint of an animate object, such as an elbow moveable joint or knee. Forming the motion capture device 200 is a first portion 100a. Further disposed as part of the first portion 100a, is an accelerometer 101 as well as a magnetic field sensor 102. Preferably the accelerometer 101 is a dual axis accelerometer having a sensitivity of approximately plus or minus 2 Gs with the two sensing axes being approximately orthogonal. Preferably the magnetic field sensor 102 is a dual axis magnetic field sensor for sensing the earth's magnetic field in two approximately orthogonal axes. An angle measuring device, in the form of an optical ranging sensor 203, is disposed as part of the first portion 100a. The optical ranging sensor 203 includes an output port and as an optical range of the optical ranging sensor varies, an output voltage provided from the output port varies in relation to the varying optical range.

In use of the first embodiment of the invention 100 by the human operator for capturing motion of the arm, the first portion 100a is strapped to an upper arm 110 in such an orientation that the optical ranging sensor 203 is facing an inside of the elbow moveable joint 112. During use of the first embodiment of the invention 100, the accelerometer 101 is for measuring the orientation of the upper arm 110 in relation to ground in two axes that are other than the same axis. The magnetic field sensor 102 is for measuring the orientation of the upper arm 110 in relation to the earth's magnetic field. Using a combination of the upper arm motion in two degrees in relation to ground as well determining the orientation of the upper arm in relation to the earth's magnetic field allows for determining the motion of a shoulder moveable joint of the human operator in many different axes and hence facilitates motion capture of the upper arm movement. Bending of the elbow moveable joint 112 is determined by the angle measuring device, in the form of the optical ranging sensor 203. FIG. 2a illustrates the elbow moveable joint 112 and lower arm in a first position and FIG. 2b illustrates the elbow moveable joint 112 and lower arm in a second position. With the optical ranging sensor 203 facing an inside of the elbow moveable joint 112, as the elbow moveable joint rotates, a distance between the lower arm and the upper arm changes and as such so does the range as sensed by the optical ranging sensor 203.

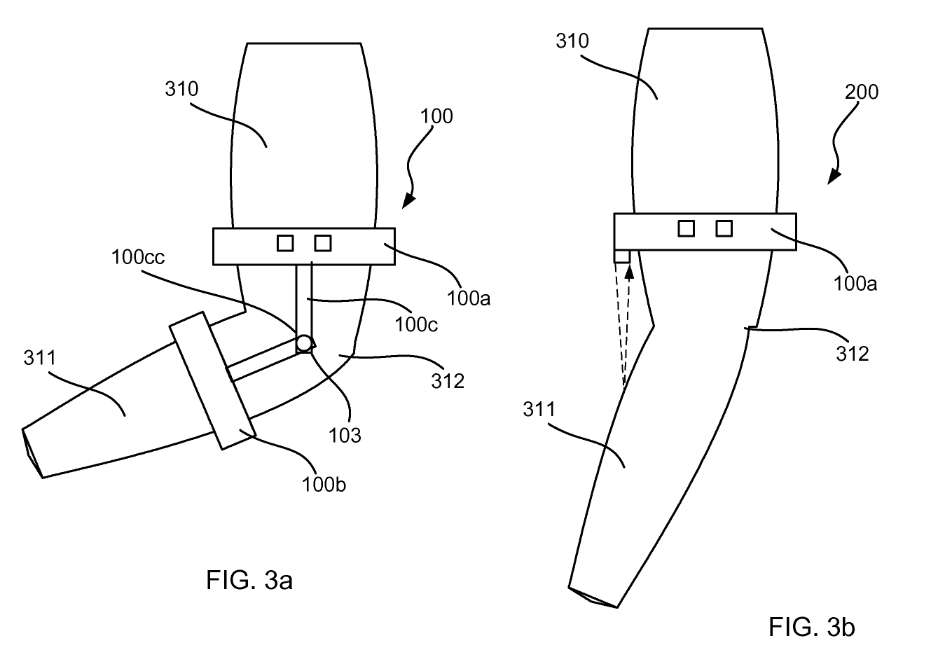

Optionally, as shown in FIG. 3a the first embodiment of the invention is optionally disposed in proximity of a knee moveable joint 312 of the human operator for facilitating motion capture of the thigh as well as bending of the knee moveable joint 312. For the first embodiment of the invention, the first portion 100a is strapped to a thigh 310, the second portion 100b is strapped to a calf 311 and the coupling 100cc is proximate the knee moveable joint 312. Preferably the first embodiment of the invention 100 is worn on the leg of the human operator in such a manner that it facilitates bending of the knee moveable joint 312. During use of the first embodiment of the invention 100, the accelerometer 101 is for measuring the orientation of the thigh 310 in relation to ground in two axes that are other than the same axis. The magnetic field sensor 102 is for measuring the orientation of the thigh 310 in relation to the earth's magnetic field. Using a combination of the thigh motion in two degrees in relation to ground as well determining the orientation of the thigh in relation to the earth's magnetic field allows for determining the motion of a hip moveable joint of the human operator in many different axes and hence facilitates motion capture of upper leg movement. Bending of the knee moveable joint 312 is determined by the angle measuring device in the form of the variable resistor 103, where as the knee bends the resistance of the variable resistor 103 changes and hence the angular motion of the knee moveable joint is determinable by the angle measuring device.

Optionally, as shown in FIG. 3b the second embodiments of the invention 200 is optionally disposed in proximity of a knee moveable joint 312 of the human operator for facilitating motion capture of the thigh as well as bending of the knee moveable joint 312. The first portion 100a is strapped to the thigh 310 in such an orientation the optical ranging sensor 203 is facing an inside of the knee 312 moveable joint. During use of the second embodiment of the invention 100, the accelerometer 101 is for measuring the orientation of the thigh 310 in relation to ground in two axes that are other than the same axis. The magnetic field sensor 102 is for measuring the orientation of the thigh 310 in relation to the earth's magnetic field. Using a combination of the thigh motion in two degrees in relation to ground as well determining the orientation of the thigh in relation to the earth's magnetic field allows for determining the motion of a hip moveable joint of the human operator in many different axes and hence facilitates motion capture of the thigh movement. Bending of the knee moveable joint 312 is determined by the angle measuring device, in the for of the optical ranging sensor 203, where the optical ranging sensor 203 faces an inside of the knee, as the knee rotates, a distance between the thigh and calf changes and as such so does the range as sensed by the optical ranging sensor 203.

For the first and second embodiments of the invention, output ports are provided for the accelerometer, magnetic field sensor and the angle measuring device. From these output ports, output signals are provided that are derived from the respective sensors.

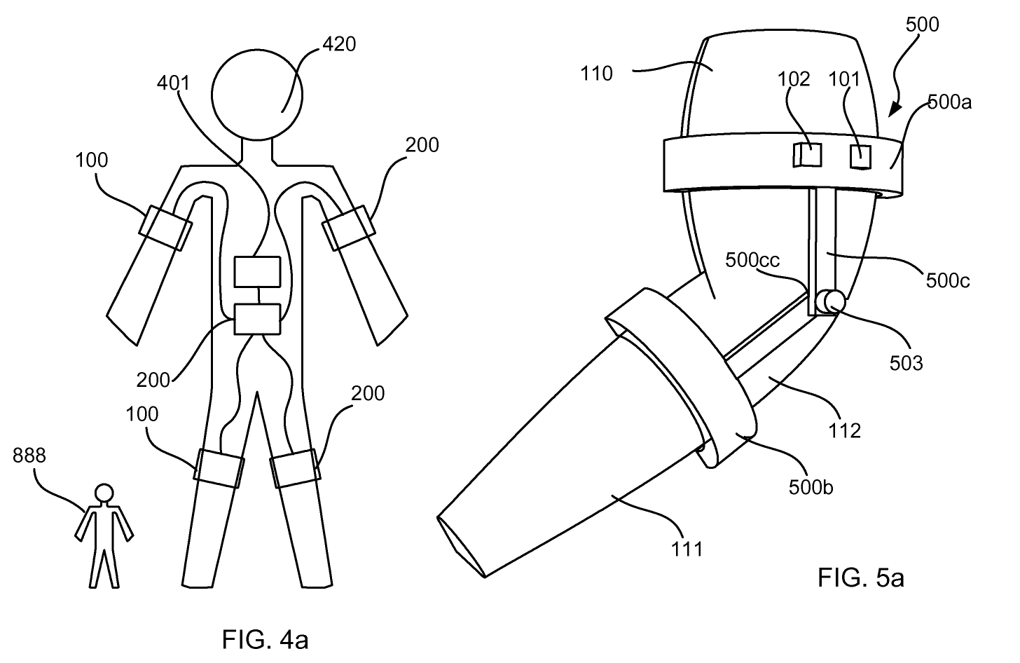

As is shown in FIG. 4a, preferably, the first and second embodiments of the invention, 100 and 200, are coupled with a control circuit 401, which includes a processor, for receiving of output signals provided by at least one of the first and second embodiments of the invention. These output signals are then combined within the control circuit 401 in a predetermined manner to represent motion of the various limbs, such as arms and legs of a user 420. For example, as shown, the first embodiment of the invention 100 is disposed about an arm of the user 420 and the second embodiment of the invention 200 is disposed about the other than the same arm of the user 420. Further preferably, the second embodiment of the invention 200 is disposed on a body part of the user 420 that is other than in proximity of the limbs of the user 420. Such a location is contemplated as being one of the stomach and chest and back and upper back. This location of the second embodiment of the invention 200 facilitates measuring the orientation of the upper body and provides a reference. Of course, when used in this manner, optionally the optical ranging sensor 203 functionality is not utilized. As shown in FIG. 4a, the first and two second embodiments of the invention, 100 and 200, are coupled with the control circuit 401 for providing of output signals thereto.

Preferably, prior to use of at lease one of the first embodiment and second embodiments of the invention, 100 and 200, respectively, the user 420 enters a calibration mode of operation to calibrate the accelerometer 101, magnetic field sensor 102 and at least one of the variable resistor 103 and optical ranging sensor 104. In calibration mode, a software program that includes a set of instructions is executed within memory of the control circuit 401 for referencing the sensors by having the user 420 perform initial movements that are specified according to the set of instructions. At end points of each predetermined movement, reference values for the sensors are stored within variables in the software program. Optionally, by holding the various limbs in predetermined positions for a predetermined amount of time results in the system to auto calibrate itself. Further optionally, an acoustic signal is provided for informing the user 420 of calibration points.

Further optionally, the control circuit 401 is coupled with a computer, in the form of a personal computer, thus facilitating movements of the user 420 to be translated into movements of a computer generated skeletal model. An example of such a model is in the form of a Biovision™ model, which has a .BVH file format. The skeletal model is built within the personal computer in such a manner to resemble the skeleton of the user 420. Upon calibration, as the user 420 moves, the control circuit 401 receives the output signals from at least one of the first and second embodiments of the invention, 100 and 200, and the skeletal model moves in an approximately representative manner along with the movements of the user 420.

Further optionally, the control circuit 401 is coupled with the robotic platform 888, preferably in the form of a humanoid robotic platform, thus facilitating movements of the user 420 to be translated into movements of the robotic platform 888. Upon calibration, as the user 420 moves, the control circuit 401 receives the output signals from at least one of the first and second embodiments of the invention, 100 and 200, and the robotic platform 888 moves in an approximately representative manner along with the movements of the user 420. Thus facilitating programming of motions for the robotic platform 888. For example, if the user moves their arms, the robotic platform 888 that comprises arms thereafter moves its arms when the user's arms are moved. Preferably this is calibrated in such a manner that the person's motions are accurately reflected in motions humanoid robotic platform. For example when the person walks forward, the robotic platform 888 propagates in a forward direction. Similarly when the person moves their arms, the robotic platform 888 moves its arms.

Further optionally, the motion capture device in accordance with one of the embodiments of the invention, 100 and 200, is used as a gaming controller, where motions of the user are sent to a gaming console for use in interacting with the game. Referring to FIG. 5a, further optionally, an actuator 503 with positional feedback, such as the angle measuring device, is disposed in proximity of the moveable joint and coupled between a first portion 500a, coupled with the upper arm 110, for example, and a second portion 500b, coupled with a lower arm 111, for example. The actuator 503 serves to affect the movement of the moveable joint, such as at least one of damping and limiting the moveable joint movement in response to a control signal. For example, in a fighting game, when the user virtually contacts their opponent during play of the game, the actuator 503 responds by limiting the range of motion of the moveable joint in response to the control signal from the gaming console. As such, this provides an approximately realistic game play because when virtual contact is made with an object in the game, a real life impact is felt by the user.

With such an installation as described in the aforementioned, the motion of the arms as well as the legs of a user are therefore useable for generating of motion capture information. Of course, for simple applications this type of motion capture is sufficient, for more complicated applications, additional degrees of freedom are optionally added so that more complicated information is generated from the movement of the legs and limbs of the user.

Further optionally the motion capture devices in accordance with embodiments of the invention are provided with a wireless transmitter and receiver in order to communicate wirelessly with each other.

Numerous other embodiments are envisaged without departing from the spirit or scope of the invention.

What is claimed is:

1. A motion capture device for being disposed in proximity of a moveable joint comprising:
a first portion coupled in proximity of the movable joint;
an accelerometer comprising an output port and coupled with the first portion for measuring an angular displacement of the first portion in relation to ground;
a magnetic field sensor comprising an output port and coupled with the first portion for measuring an orientation of the first portion in relation to the earth's magnetic field;
an angle measuring device comprising an output port and coupled with the first portion for measuring an angle of the moveable joint.

2. A motion capture according to claim 1 wherein the angle measuring device comprises a variable resistor for varying a resistance thereof in response to a change in the angle of the moveable joint.

3. A motion capture device according to claim 2 comprising:
a second portion coupled to the first portion using a pivotal coupling, wherein the pivotal coupling facilitates rotation of the first portion in relation to the second portion, wherein the variable resistor is for varying the resistance in response to the angular change of the first portion in relation to the second portion as the pivotal coupling rotates.

4. A motion capture device according to claim 3 wherein the first portion is for coupling to a thigh of a user and the second portion is for coupling to a calf of the user.

5. A motion capture device according to claim 3 wherein the first portion is for coupling to an upper arm and the second portion is for coupling to a forearm.

6. A motion capture device according to claim 3 comprising an actuator disposed between the first portion and the second portion for at least one of damping and limiting motion of the movable joint in response to a control signal.

7. A motion capture according to claim 1 wherein the angle measuring device comprises an optical ranging sensor comprising an output port for providing an output voltage and coupled in proximity of the moveable joint, where as the angle of the moveable joint varies the output voltage varies.

8. A motion capture according to claim 6 wherein the optical ranging sensor is disposed in proximity of the moveable joint and facing an inside of the moveable joint.

9. A motion capture device according to claim 7 wherein the first portion is for coupling to a thigh of a user with the optical ranging sensor disposed for facing the inside of the knee moveable joint for optically ranging from reflected light from a calf of the user.

10. A motion capture device according to claim 7 wherein the first portion is for coupling to an upper arm of a user with the optical ranging sensor disposed for facing the inside of the elbow moveable joint for optically ranging from reflected light from a forearm of the user.

11. A motion capture device according to claim 1 comprising a control circuit coupled with the output port of the accelerometer and with the output port of the magnetic field sensor, the control circuit for receiving of acceleration and magnetic field information for determining an orientation of the motion capture device in relation to ground as well as to the earth's magnetic field.

12. A motion capture device according to claim 10 wherein the control circuit comprises a transmitter circuit for one of wireless and wired transmission of motion capture information from the motion capture device to a robotic platform.

13. A motion capture device according to claim 10 wherein the control circuit comprises a transmitter circuit for one of wireless and wired transmission of motion capture information from the motion capture device to a robotic platform.

14. A method of motion capture comprising:
providing a first portion coupled in proximity of the movable joint;
providing an accelerometer comprising an output port and coupled with the first portion;
providing a magnetic field sensor comprising an output port and coupled with the first portion;
providing an angle measuring device disposed in proximity of the moveable joint;
measuring an angular displacement of the first portion in relation to ground;
measuring an orientation of the first portion in relation to the earth's magnetic field;
measuring an angle of the moveable joint;
processing the measured angular displacement and the orientation in relation to the earth's magnetic field in order to determine an orientation of the first portion in two axes;
processing the angle of the moveable joint in order to determine a bending angle of the movable joint.

15. A method according to claim 14 wherein the angle measuring device comprises one of a variable resistor and an optical ranging sensor.
